(19) United States
(12) Patent Application Publication
(10) Pub. No.: US 2026/0068918 A1
(43) Pub. Date: Mar. 12, 2026

(54) FAT-SOLUBLE VITAMIN POWDER FOR FORTIFYING FOOD PRODUCTS

(71) Applicant: DSM IP ASSETS B.V., Maastricht (NL)

(72) Inventors: Gabriela BADOLATO BÖNISCH, Kaiseraugst (CH); Casper DE BOER, Kaiseraugst (CH); Thomas LINDEMANN, Kaiseraugst (CH); Christian SCHAEFER, Kaiseraugst (CH); Bernd SCHLEGEL, Kaiseraugst (CH); Ralph SCHNEITER, Kaiseraugst (CH); Olivia Brigitte VIDONI, Kaiseraugst (CH); Dirk Oliver WOERNE, Kaiseraugst (CH)

(21) Appl. No.: 19/108,596

(22) PCT Filed: Sep. 5, 2023
(86) PCT No.: PCT/EP2023/074253

§ 371 Date: Mar. 4, 2025

(30) Foreign Application Priority Data
Sep. 9, 2022 (EP) 22194742.7

(51) Int. Cl. A23L 33/155; A23L 29/219; A23L 29/281; A23L 29/30

(52) U.S. Cl. CPC A23L 33/155; A23L 29/219; A23L 29/284; A23L 29/30

(57) ABSTRACT

The present invention relates to a formulation, which comprises a fat-soluble vitamin and which can be used for fortifying early life nutrition products.

The present invention relates to a formulation, which comprises a fat-soluble vitamin and which can be used for fortifying food products (especially infant formulations).

Examples of fat-soluble vitamins are vitamin A, vitamin D, Vitamin K and/or its derivatives or mixtures thereof. Preferred is vitamin A and/or its derivative, more preferred vitamin A esters and here especially the vitamin A palmitate.

Vitamin A is an essential micronutrient whose deficiency is still a major health concern in many regions of the world. It plays an essential role in human growth and development, immunity, and vision, but may also help prevent several other chronic diseases. The total amount of vitamin A in the human diet often falls below the recommended dietary allowance of approximately 900-1000 μg/day for a healthy adult. Moreover, a significant proportion of vitamin A may be degraded during food processing, storage, and distribution, thereby reducing its bioactivity. Finally, the vitamin A in some foods has a relatively low bioavailability, which further reduces its efficacy. The World Health Organization has recommended fortification of foods and beverages as a safe and cost-effective means of addressing vitamin A deficiency. However, there are several factors that must be overcome before effective fortified foods can be developed, including the low solubility, chemical stability, and bioavailability of this oil-soluble vitamin. Consequently, strategies are required to evenly disperse the vitamin throughout food matrices, to inhibit its chemical degradation, to avoid any adverse interactions with any other food components, to ensure the food is palatable, and to increase its bioavailability.

Therefore, there is always a need for formulation, which can be used for food fortification.

Food safety is of utmost importance and the inclusion of non-natural or unbeneficial ingredients in foodstuffs is getting more and more attention. Especially for infant food (early life nutrition) there are strict regulations of what ingredients are allowed and wanted in formulations.

Early-life nutrition encompasses the first 1000 days of a child's life, from conception to their second birthday, as well as the toddler years. As healthcare professionals, it is essential to understand the importance of early life nutrition in shaping the long-term health outcomes of infants and children.

The problem of fat-soluble vitamins is that they are prone to oxidize. This means that the content of these vitamins decreases during storage (as well as during the production of the food product). This is a problem in the production of formulation comprising these vitamins as well as during the storage of products comprising these vitamins.

To obtain and keep a certain amount of these ingredients in the final product, a usual way is to add these vitamins in excess.

Another way to solve that problem, antioxidants can be added to the vitamins. A very common and usually antioxidant is BHT (butyl hydroxy toluene). At the moment many vitamin A powders on the market contain BHT or other critical antioxidants (for early life nutrition products).

BHT (butylated hydroxytoluene) is a lab-made chemical that is added to foods as a preservative, but it has a negative reputation both from a health and an environmental perspective.

For that reason there is desire to avoid BHT in food products (or in formulations, which are used in food products).

Also ascorbic acid, sodium ascorbate (an any other ascorbic acid salts) as well ascorbyl palmitate (and any other ascorbyl esters) can be excluded is in many countries not allowed or restricted in use as an antioxidant in infant food.

Also other synthetic antioxidants such as BHA (butylated hydroxyanisole) and EMQ (ethoxyquin).

Therefore, the goal of the present invention was to find formulation with a high amount of at least one fat-soluble vitamin, which does not comprise BHT or sodium ascorbate. Such a formulation needs to be stable, easy to produce and which can be used in a large variety of food products (especially infant food).

Surprisingly, it was found that a solid formulation which comprises
(i) at least one fat soluble vitamin, and
(ii) at least one hydrocolloid, and
(iii) at least one starch hydrolysate, and
(iv) tocopherol,
   with the proviso that the formulation does not comprise any BHT, any ascorbic acid, any sodium ascorbate (an any other ascorbic acid salts), any ascorbyl palmitate (and any other ascorbyl esters), any BHA and any EMQ.
   shows all the advantages as listed above.

Therefore, the present invention relates to a solid formulation (SF) comprising
(i) at least one fat soluble vitamin, and
(ii) at least one hydrocolloid, and
(iii) at least one starch hydrolysate, and
(iv) tocopherol,
   with the proviso that the formulation does not comprise any BHT, any ascorbic acid, any sodium ascorbate (an any other ascorbic acid salts), any ascorbyl palmitate (and any other ascorbyl esters), any BHA and any EMQ.

Therefore, the present invention relates to a solid formulation (SF′) consisting (essentially) of
(i) at least one fat soluble vitamin, and
(ii) at least one hydrocolloid, and
(iii) at least one starch hydrolysate, and
(iv) tocopherol.

The solid formulation according to the present invention does not comprise any BHT, any ascorbic acid, any sodium ascorbate (an any other ascorbic acid salts), any ascorbyl palmitate (and any other ascorbyl esters), any BHA and any EMQ. This means that the solid is (substantially) free from any BHT, any ascorbic acid, any sodium ascorbate (an any other ascorbic acid salts), any ascorbyl palmitate (and any other ascorbyl esters), any BHA and any EMQ.

It might be that traces of these compounds may be present in the formulation. But they are not added intentionally. It may be that traces of such compounds are present in the ingredients (i) to (iv) or in other ingredients, which may be part of the solid formulation according to the present invention.

Surprisingly, it was found, the formulation according to the present invention provided excellent stability as such as well as in food products.

Due to fact that the formulation for that purpose has no BHT, ascorbic acid, sodium ascorbate (an any other ascorbic acid salts), ascorbyl palmitate, BHA and EMQ in it, the present formula fulfils the requirements for early life nutrition. Also, the formulation production has less complexity and the label of the final food product is less complex due to the inclusion of less ingredients.

It is also of advantage that the formulation according to the present invention does not comprise any prebiotic and/or probiotic compounds.

Therefore, the present invention relates to a solid formulation (SF″) which is the solid formulation (SF), wherein the formulation does not comprise any prebiotic and/or probiotic compounds.

The formulation according to the present invention comprises at least one fat-soluble vitamin. Fat-soluble vitamins are vitamin A, vitamin D, Vitamin K and/or its derivatives or mixtures thereof. Preferred is vitamin A and/or its derivative, more preferred are vitamin A esters and especially preferred is vitamin A palmitate.

Therefore, the present invention relates to a solid formulation (SF1), which is the solid formulation (SF), (SF′) or (SF″), wherein the at least one fat-soluble vitamin is chosen from the group consisting of vitamin A, vitamin D, Vitamin K and its derivatives thereof.

Therefore, the present invention relates to a solid formulation (SF1′), which is the solid formulation (SF), (SF′) or (SF″), wherein the at least one fat-soluble vitamin is chosen from the group consisting of vitamin A and derivatives thereof.

Therefore, the present invention relates to a solid formulation (SF1″), which is the solid formulation (SF), (SF′) or (SF″), wherein the fat-soluble vitamin is a vitamin A ester.

Therefore, the present invention relates to a solid formulation (SF1′″), which is the solid formulation (SF), (SF′) or (SF″), wherein the fat-soluble vitamin is a vitamin A palmitate.

The content of the at least one fat-soluble vitamin is usually from 3 to 30 weight-% (wt.-%), based on the total weight of the solid formulation. Preferably from 5 to 25 wt.-%, more preferably from 10 to 20 wt.-%, based on the total weight of the solid formulation.

Therefore, the present invention relates to a solid formulation (SF2), which is the solid formulation (SF), (SF′), (SF″), (SF1), (SF1′), (SF1″) or (SF1″), wherein the content of the at least one fat-soluble vitamin is from 3 to 30 wt.-%, based on the total weight of the solid formulation.

Therefore, the present invention relates to a solid formulation (SF2′), which is the solid formulation (SF), (SF′), (SF″), (SF1), (SF1′), (SF1″) or (SF1″), wherein the content of the at least one fat-soluble vitamin is from 5 to 25 wt.-%.

Therefore, the present invention relates to a solid formulation (SF2″), which is the solid formulation (SF), (SF′), (SF″), (SF1), (SF1′), (SF1″) or (SF1″), wherein the content of the at least one fat-soluble vitamin is from 10 to 20 wt.-%, based on the total weight of the solid formulation.

The solid formulation according to the present invention comprises at least one hydrocolloid.

In the context of the present invention, hydrocolloids are polysaccharides, gelatin of low bloom, medium bloom or high bloom from fish, pork or bovine, caseines/caseinates and other proteinaceous hydrocolloids.

Preferred hydrocolloids according to the invention are polysaccharides.

In the context of the present invention, the term polysaccharide as used herein includes xanthan gum, gum acacia, pectin, guar gum, caroub gum, alginates, celluloses, cellulose derivatives, starch and starch derivatives. Preferred polysaccharides according to the present invention are gum acacia, starch, starch derivatives, more preferred are gelatinized starch and modified food starch and especially preferred are modified food starches.

In the context of the present invention, the term “modified food starch” as used herein relates to modified starches that are made from starches substituted by known chemical methods with hydrophobic moieties. For example starch may be treated with cyclic dicarboxylic acid anhydrides such as succinic and/or glutaric anhydrides, substituted with an alkyl or alkenyl hydrocarbon group.

A very common and preferred modified starch is starch sodium octenyl succinate (OSA-starch). OSA-starch as used herein denotes any starch (from any natural source such as corn, wheat, tapioca, potato or synthesized) that was treated with octenyl succinic anhydride. The degree of substitution, i.e. the number of esterified hydroxyl groups with regard to the total number of hydroxyl groups usually varies in a range of from 0.1 percent to 10 percent, preferably in a range of from 0.5 percent to 5 percent, more preferably in a range of from 2 percent to 4 percent.

OSA-starches are commercially available e.g. from Ingredion under the trade names HiCap 100, Capsul HF, Capsul HS, Purity Gum 2000, UNI-PURE, HYLON VII from Roquette Freres; from Cargill under the trade name C*EmCap or from Tate and Lyle.

The content of the at least one hydrocolloid is usually from 20 to 85 wt.-%, based on the total weight of the solid formulation, preferably from 25 to 80 wt.-%, more preferably from to 70 wt.-%, based on the total weight of the solid formulation.

Therefore, the present invention relates to a solid formulation (SF3), which is the solid formulation (SF), (SF′), (SF″), (SF1), (SF1′), (SF1″), (SF1″), (SF2), (SF2′) or (SF2″), wherein the at least one hydrocolloid is chosen from the group consisting of polysaccharides, gelatin of low bloom, medium bloom or high bloom from fish, pork or bovine, caseines/caseinates and other proteinaceous hydrocolloids.

Therefore, the present invention relates to a solid formulation (SF3′), which is the solid formulation (SF), (SF′), (SF″), (SF1), (SF1′), (SF1″), (SF1″), (SF2), (SF2′) or (SF2″), wherein the at least one hydrocolloid is chosen from the group consisting of xanthan gum, gum acacia, pectin, guar gum, caroub gum, alginates, celluloses, cellulose derivatives, such as starch and starch derivatives.

Therefore, the present invention relates to a solid formulation (SF3″), which is the solid formulation (SF), (SF′), (SF″), (SF1), (SF1′), (SF1″), (SF1″), (SF2), (SF2′) or (SF2″), wherein the hydrocolloid is modified food starch.

Therefore, the present invention relates to a solid formulation (SF3″), which is the solid formulation (SF3″), wherein the modified food starch is starch sodium octenyl succinate.

Therefore, the present invention relates to a solid formulation (SF4), which is the solid formulation (SF), (SF′), (SF″), (SF1), (SF1′), (SF1″), (SF1″), (SF2), (SF2′), (SF2″), (SF3), (SF3′), (SF3″) or (SF3″), wherein the content of the at least one hydrocolloid is 20 to 85 wt.-%, based on the total weight of the solid formulation.

Therefore, the present invention relates to a solid formulation (SF4′), which is the solid formulation (SF), (SF′), (SF″), (SF1), (SF1′), (SF1″), (SF1′″), (SF2), (SF2′), (SF2″), (SF3), (SF3′), (SF3″) or (SF3″), wherein the content of the at least one hydrocolloid is from 25 to 80 wt.-%, based on the total weight of the solid formulation.

Therefore, the present invention relates to a solid formulation (SF4″), which is the solid formulation (SF), (SF′), (SF″), (SF1), (SF1′), (SF1″), (SF1″), (SF2), (SF2′), (SF2″), (SF3), (SF3′), (SF3″) or (SF3″), wherein the content of the at least one hydrocolloid is from 25 to 70 wt.-%, based on the total weight of the solid formulation.

The solid formulation according to the present invention comprises at least one starch hydrolysate.

Hydrolyzed starches are the dried products or aqueous dispersions of saccharides (hydrolysates) obtained by hydrolysis of native starch by using suitable acid or enzymes. Starch hydrolysates denote dextrins, maltodextrins and glucose syrup.

Preferred are starch hydrolysates with a DE-value of 10 to 30, more preferred are hydrolysates with a DE-value of 15 to 25, most preferred are hydrolysates with a DE-value of 17 to 20.

The DE-value characterizes the reducing capacity based on the reducing capacity of anhydrous dextrose and is determined by the DIN 10 308 method, edition 5.71, of the Deutsche Normenausschuss Lebensmittel und landwirtschaftliche Produkte.

Therefore, the present invention relates to a solid formulation (SF5), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′) or (SF4″), wherein the at least one starch hydrolysate is chosen from the group consisting of dextrins, maltodextrins and glucose syrup.

Therefore, the present invention relates to a solid formulation (SF5′), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′) or (SF4″), wherein the at least one starch hydrolysate has a DE-value of 10 to 30.

Therefore, the present invention relates to a solid formulation (SF5″), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′) or (SF4″), wherein the at least one starch hydrolysate has a DE-value of 15 to 25.

Therefore, the present invention relates to a solid formulation (SF5″), which is the solid formulation (SF), (SF′), (SF″), (SF1), (SF1′), (SF1″), (SF1′″), (SF2), (SF2′), (SF2″), (SF3), (SF3′), (SF3″), (SF3″), (SF4), (SF4′) or (SF4″), wherein the at least one starch hydrolysate has a DE-value of 17 to 20.

The solid formulation according to the present invention comprises 10-60 wt.-%, based on the total weight of the solid formulation, of at least one starch hydrolysate. Preferably from 15 to 55 wt.-%, more preferably 18 to 55 wt.-%, based on the total weight of the solid formulation.

Therefore, the present invention relates to a solid formulation (SF6), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″) or (SF5″), wherein the content of the at least one starch hydrolysate is 10 to 60 wt.-%, based on the total weight of the solid formulation.

Therefore, the present invention relates to a solid formulation (SF6′), which is the solid formulation (SF), (SF′), (SF″), (SF1), (SF1′), (SF1″), (SF1′″), (SF2), (SF2′), (SF2″), (SF3), (SF3′), (SF3″), (SF3″), (SF4), (SF4′), (SF4″), (SF5), (SF5′), (SF5″) or (SF5″), wherein the content of the at least one starch hydrolysate is 15 to 55 wt.-%, based on the total weight of the solid formulation.

Therefore, the present invention relates to a solid formulation (SF6″), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″) or (SF5″), wherein the content of the at least one starch hydrolysate is 18 to 55 wt.-%, based on the total weight of the solid formulation.

The solid formulation according to the present invention comprises tocopherol. In the context of the present invention the term “tocopherol” encompasses DL-α-tocopherol, γ-tocopherol, δ-tocopherol, and mixed tocopherol.

The content of the tocopherol from is from 0.1 to 5 wt.-%, based on the total weight of the solid formulation, preferably from 0.2 to 4 wt.-%, more preferably from 0.5 to 3 wt.-%, based on the total weight of the solid formulation.

Therefore, the present invention relates to a solid formulation (SF7), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5′″), (SF6), (SF6′) or (SF6″), wherein the content of the tocopherol is 0.1 to 5 wt.-%, based on the total weight of the solid formulation.

Therefore, the present invention relates to a solid formulation (SF7′), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′) or (SF6″), wherein the content of the tocopherol is 0.2 to 4 wt.-%, based on the total weight of the solid formulation.

Therefore, the present invention relates to a solid formulation (SF7″), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′) or (SF6″), wherein the content of the tocopherol is 0.5 to 3 wt.-%, based on the total weight of the solid formulation.

Furthermore, the solid formulation according to the present invention can also comprise some residual water. The content is depending on the drying process, which has been used to dry the solid formulation.

The water content of the solid formulation according to the present invention is usually and preferably below 5 wt-%, based on the total weight of the solid formulation. More preferably the water content is below 4 wt-%, based on the total weight of the solid formulation.

Therefore, the present invention relates to a solid formulation (SF8), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′) or (SF7″), wherein the water content of the solid formulation is below 5 wt-%, based on the total weight of the solid formulation.

Therefore, the present invention relates to a solid formulation (SF8′), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′) or (SF7″), wherein the water content of the solid formulation is below 4 wt-%, based on the total weight of the solid formulation.

The solid formulation according to the invention may further contain additional ingredients such powdering agent, oil, anti-caking agents, e.g. tri-calcium phosphate, such as silicon dioxide, flavours, and colors.

Such additional ingredients may be present in the invention up to 10 wt-%, based on the total weight of the solid formulation.

Therefore, the present invention relates to a solid formulation (SF9), which is the solid formulation (SF), (SF1), (SF″), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8) or (SF8′), wherein the solid formulation comprises at least one additional ingredient chosen from the group consisting of powdering agent, oil, anti-caking agents, e.g. tri-calcium phosphate and silicates, such as silicon dioxide or sodium aluminium silicate, flavours and colors.

Therefore, the present invention relates to a solid formulation (SF9′), which is the solid formulation (SF9), wherein the content of the at least one additional ingredient is up to 10 wt-%, based on the total weight of the solid formulation.

The ingredients (i) to (iv) as well as the residual water and the additional ingredients (such as powdering agent, anti-caking agents, e.g. tri-calcium phosphate, such as silicon dioxide, flavours and colors) are in the form of particles, which form the solid formulation according to the present invention.

Preferably, the solid formulation according to the present invention does not comprise any sucrose (such as sucrose, lactose, trehalose, cellobiose and chitobiose (preferably sucrose)).

Therefore, the present invention relates to a solid formulation (SF10), which is the solid formulation (SF), (SF1), (SF″), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9) or (SF9′), wherein which is free of any disaccharide chosen from the group consisting of sucrose, lactose, trehalose, cellobiose and chitobiose (preferably sucrose).

Preferably, the solid formulation according to the present invention does not comprise any silicates.

Optionally, the particles, which form the solid formulation according to the present invention can be coated as well, which means they can have a coating layer.

The coating layer can be any commonly known coating layer. It could also be a powder coating layer. Such a powder coating can be made from starch (such as corn starch).

The coating layer can be up to 45 wt-% of the coated solid formulation, based on the total weight of the coated solid formulation. This means that at least 55 wt-% is the coated solid formulation is at least one solid formulation as defined above.

Therefore, the present invention relates to a coated solid formulation (CSF1), which is the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9), (SF9′) or (SF10) coated with a coating layer.

Therefore, the present invention relates to a solid formulation (CSF1′), which is the coated solid formulation (CSF1), wherein the coating layer is up to 45 wt-% of the coated solid formulation, based on the total weight of the coated solid formulation.

The solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9), (SF9′) and (SF10) as well as the coated solid formulation (CSF1) or (CSF1′) can be produced by commonly known method such as spray drying, powder catch, freeze drying, granulation, agglomeration or extrusion.

The particle size of the solid formulation and coated solid formulation according to the present invention can vary according to the process, which is used to produce the (coated) solid formulation. A usual size range of the particle distribution (Dv (10)) is 10 μm up to 500 μm, preferably 10 μm up to 250 μm.

Therefore, the particle size distribution (Dv (10)) of the (coated) solid formulation (SF), (SF′), (SF1), (SF″), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9), (SF9′), (SF10), (CSF1) and (CSF1′) is in the range of from 10 μm up to 500 μm, preferably from 10 μm up to 250 μm.

The formulation according to the present invention is used to fortify food products, especially infant formulations (early life nutrition products).

The formulation can be incorporated into a food product, especially into an infant formulation (early life nutrition product).

It is also possible to mix the formulation according the present invention with into a premix formulation (comprising other ingredients (such as vitamins, trace minerals, etc) for the desired use) which is then incorporated into a food product, especially into an infant formulation (early life nutrition product).

The (coated) solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9), (SF9′), (SF10), (CSF1) and/or (CSF1′) is used to fortify food products.

The (coated) solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5″), (SF6), (SF6′), (SF6″), (SF7), (SF7′), (SF7″), (SF8), (SF8′), (SF9), (SF9′), (SF10), (CSF1) and/or (CSF1′) is used to fortify early life nutrition products.

Furthermore, the present invention relates to food products fortified by the solid formulation (SF), (SF′), (SF″), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5′″), (SF6), (SF6′), (SF6″), (SF7), (SF7′), (SF7″), (SF8), (SF8′), (SF9), (SF9′), (SF10), (CSF1) and/or (CSF1′).

Furthermore, the present invention relates to early life nutrition products fortified by the solid formulation (SF), (SF′), (SF1), (SF1′), (SF1″), (SF1″), (SF2), (SF2′), (SF2″), (SF3), (SF3′), (SF3″), (SF3″), (SF4), (SF4′), (SF4″), (SF5), (SF5′), (SF5″), (SF5′″), (SF6), (SF6′), (SF6″), (SF7), (SF7′), (SF7″), (SF8), (SF8′), (SF9), (SF9′), (SF10), (CSF1) and/or (CSF1′).

The following examples illustrate the present invention.

All the parts and percentages in the Examples are related to the weight (when not otherwise stated) and the temperature is given in ° C. (when not otherwise stated).

### EXAMPLES

### Example 1

A matrix solution was prepared by dissolving 180 g Hicap 100, 56 g Gum Acacia and 97 g Glucidex 19D in 222 g water at 65° C. while stirring. The pH of the solution was adjusted to 5.0 by adding 13.6 g of a 2M sodium acetate solution. 66 g vitamin A palmitate (1,7 MioIU/g) and 4.2 g mixed tocopherols (70IP) were mixed at 60° C. for 10 minutes and of this mixture 68.3 g was added to the matrix solution. The mixture was emulsified until the particle size D (0,5) was below 1 μm as measured by Malvern Mastersizer 2000. The viscosity was adjusted by the addition of water and the emulsion was spray dried to yield 199 g dry powder with an LOD of 2.01%. The final dry powder had the composition of Exp. 1

The powder shown as Exp. 2 is produced according to example 1.

TABLE 1

| | Exp. 1 | Exp. 2 |
|---|---|---|
| Ingredients | [wt-%] | [wt-%] |
| HiCap 100 | 43.9 | 29.3 |
| Gum Acacia | 13.7 | 4.9 |
| Maltodextrin DE19 (Glucidex 19D) | 23.7 | 47.1 |
| Vitamin A Palmitate | 15.7 | 15.6 |
| Mixed Tocopherol 70IP | 1.0 | 1.0 |
| residual water | 2.01 | 2.16 |

The powder shown as Exp. 3 is produced according to example 1. This is a comparative Example. This formulation comprises sodium ascorbate

TABLE 2

| | Exp. 3 (comparison Example) |
|---|---|
| Ingredients | [wt-%] |
| Capsul HS | 63.5 |
| Maltodextrin DE2023 | 10.8 |
| Sodium Ascorbate | 1.0 |
| Sodium Benzoate | 0.6 |
| Vitamin A Palmitate | 16.2 |
| MCT | 5.0 |
| tocopherol 70IP | 2.9 |

### Applications Tests

Stability of Vitamin A forms of the Examples were assessed in a typical infant formula vitamin premix with the final composition containing 3% of vitamin A product form, 46% lactose, 16% inositol, 16% taurine, 7% vit. E, 3% Vitamin D3, 2% Vitamin K1 and 7% of other ingredients (vit. B3, calcium, vit. B12, vit. B7, vit. B9, vit. B2, vit. B1 and vit. B6). Note that concentrations are given for the product forms.

For the blend preparation, 485 g of premix were filled in a 1 Litre glass bottle with 15 g of vitamin A product. Then the bottle content was mixed for 10 min at 22 rpm in an orbital mixer (Turbula®, Type T2 C Shaker Mixer). The obtained mixture was then aliquoted in aluminium bags and stability studies of vitamin A palmitate were conducted at 30° C. up to 3 months. Initial determination of vitamin A content was performed in duplicate using 3 different bags with double measurement, whereas the following time points were based on duplicate measurement of 2 different bags.

TABLE 3
Stability data

| Ingredients | 1 month | 3 months |
|---|---|---|
| Formulation of Exp. 1 | 100 | 81 |
| Formulation of Exp. 2 | 100 | 98.5 |
| Formulation of Exp. 3 | 100 | 58 |

It can be seen that the formulation according to the present invention show an improved stability.

1. A solid formulation comprising
(i) at least one fat soluble vitamin, and
(ii) at least one hydrocolloid, and
(iii) at least one starch hydrolysate, and
(iv) tocopherol,
with the proviso that the formulation does not comprise any BHT, any ascorbic acid, any sodium ascorbate (an any other ascorbic acid salts), any ascorbyl palmitate (and any other ascorbyl esters), any BHA and any EMQ.

2. Solid formulation according to claim 1, wherein the at least one fat-soluble vitamin is chosen from the group consisting of vitamin A, vitamin D, Vitamin K and its derivatives thereof.

3. Solid formulation according to claim 1, wherein the at least one fat-soluble vitamin is chosen from the group consisting of vitamin A and derivatives thereof.

4. Solid formulation according to claim 1, wherein the content of the at least one fat-soluble vitamin is from 3 to 30 wt.-%, based on the total weight of the solid formulation.

5. Solid formulation according to claim 1, wherein the content of the at least one fat-soluble vitamin is from 5 to 25 wt.-%, based on the total weight of the solid formulation.

6. Solid formulation according to claim 1, wherein the at least one hydrocolloid is chosen from the group consisting of polysaccharides, gelatin of low bloom, medium bloom or high bloom from fish, pork or bovine, caseins/caseinates and other proteinaceous hydrocolloids.

7. Solid formulation according to claim 1, wherein the at least one hydrocolloid is chosen from the group consisting of xanthan gum, gum acacia, pectin, guar gum, caroub gum, alginates, celluloses, cellulose derivatives, such as starch and starch derivatives.

8. Solid formulation according to claim 1, wherein the content of the at least one hydrocolloid is 20 to 85 wt.-%, based on the total weight of the solid formulation.

9. Solid formulation according to claim 1, wherein the at least one starch hydrolysate is chosen from the group consisting of dextrins, maltodextrins and glucose syrup.

10. Solid formulation according to claim 1, wherein the content of the at least one starch hydrolysate is 10 to 60 wt.-%, based on the total weight of the solid formulation.

11. Solid formulation according to claim 1, wherein the content of the tocopherol is 0.1 to 5 wt.-%, based on the total weight of the solid formulation.

12. Solid formulation according to claim 1, wherein the water content of the solid formulation is below 5 wt-%, based on the total weight of the solid formulation.

13. Use of a solid formulation according to claim 1 to fortify early life nutrition (ELN) products.

14. Early life nutrition products fortified by a solid formulation according to claim 1.
